(19) United States
(12) Patent Application Publication
(10) Pub. No.: US 2008/0238066 A1
(43) Pub. Date: Oct. 2, 2008

(54) Methods and devices for outdoor cooking

(76) Inventor: Carl T. Muirbrook, Turlock, CA (US)

Correspondence Address: SHARON J. ADAMS;ADAMS LAW OFFICE, 2140 SHATTUCK AVE. SUITE 707, BERKELEY, CA, 94704, US

(21) Appl. No.: 12/075,235

(22) Filed: Mar. 10, 2008

Related U.S. Application Data
(60) Provisional application No. 60/905,962, filed on Mar. 9, 2007.

(51) Int. Cl. B60R 27/00

(52) U.S. Cl. 280/762

(57) ABSTRACT

A hitch assembly removeably attachable to a vehicle hitch and extending away from the vehicle, comprising, in part, a lower platform, upper platform and locking platform. A pole is inserted through apertures in the upper and locking platforms and rests on the lower platform. The pole is adjusted to a substantially vertical position and locked in place with a locking assembly. A cooking surface may be suspended from the pole, and a heat source under the surface is used to heat and cook food. A handle is used to lift, turn or otherwise move the hot cooking surface.

This application claims priority to U.S. Provisional Patent Application 60/905,962, filed Mar. 9, 2007, and is herein incorporated by reference in its entirety.

### BACKGROUND OF THE INVENTION

1. Field of the Invention

The invention is in the field of accessories and methods used for outdoor cooking, including a hitch assembly used to removeably attach a pole in a substantially vertical position to a vehicle. The hitch assembly contains a support and locking mechanism to position and lock the pole in a vertical or substantially vertical position. A cooking surface such as a grill or griddle may be attached to the pole and will project horizontally away from the vehicle, allowing a heat supply to be placed under the cooking surface, for cooking food. The pole is also capable of receiving other items to be attached to the pole, as desired. The cooking surface has an aperture capable of receiving a handle, where said handle may be used to lift, turn, carry or otherwise move a cooking surface, particularly when the surface is hot.

2. Description of the Related Art

Many people enjoy outdoor cooking while camping, at tailgate parties, parks or other locations. There are many devices for outdoor cooking. Some are freestanding, while others rely on a pole inserted into the ground and used to support a flat cooking surface such as a grill or griddle.

Often the cooking surfaces at parks, campgrounds, and other locations are dirty or greasy from previous cookouts by others, and many people prefer to bring and use their own cooking surface.

Cooking surfaces are also often used in parking lots at sporting events, and at other tailgate parties. Generally, at tailgate parties, there is no way to drive a pole into the ground since the ground will most likely be covered with asphalt. In these situations the hosts must bring their own heat supply and cooking surface because there are no pre-existing outdoor cooking accommodations. However, there have not been good methods and devices for supporting these cooking surfaces, ensuring the cooking surfaces are substantially horizontal, or for handling the cooking surfaces once they are hot.

### BRIEF SUMMARY OF THE INVENTION

The hitch assembly has a proximal and distal end, where the proximal end is capable of removeably attaching to a vehicle through an extender. In one embodiment the extender may telescopically extend and retract so that distance from the distal end to the vehicle may be varied. The distal end of the hitch assembly has an upper and lower platform permanently connected to each other in a fixed, parallel position by a vertical support. A locking platform rests on top of the upper platform and may be locked into position by a locking assembly.

Both the locking platform and upper platform have apertures capable of receiving a pole. The pole is inserted through these apertures and rests on the upper surface of the lower platform. In one embodiment, the aperture in the upper platform is capsule shaped so that the pole may be adjusted, as needed, to achieve a vertical or substantially vertical position. Once the pole is vertical, a cooking surface or other device may be connected with the pole, and will suspend from the pole away from the vehicle.

When a cooking surface is connected with the pole and is extending away from the vehicle, a heat source may provide heat to the cooking surface, allowing food to be cooked. Once the cooking surface is hot, the handle may be used to lift, turn or otherwise move the cooking surface.

### DESCRIPTION OF THE VIEWS

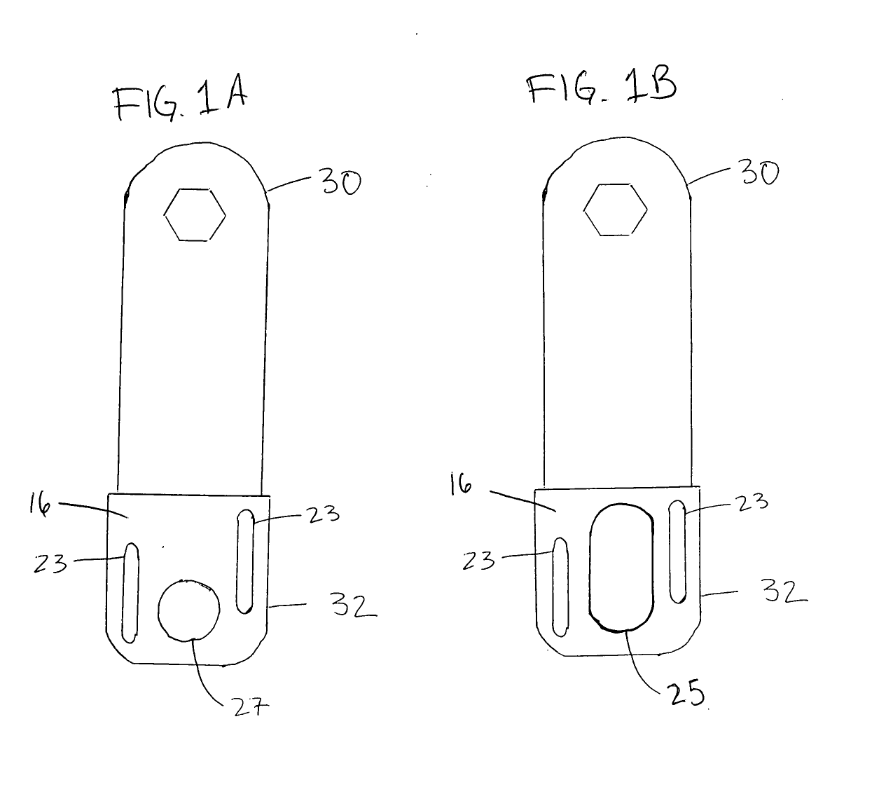

FIGS. 1A and 1B shows top views of embodiments of the hitch assembly.

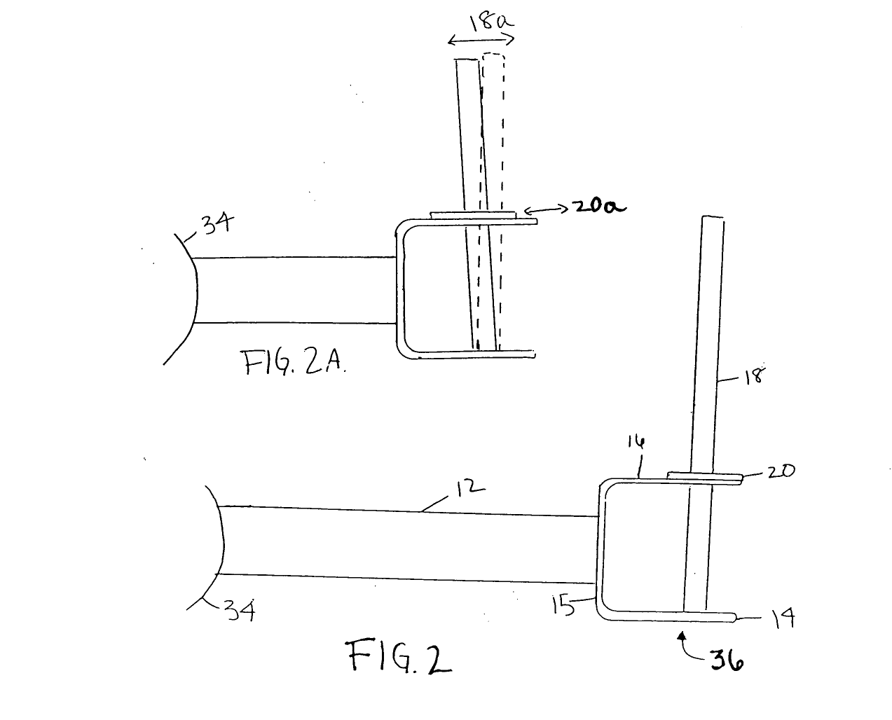

FIG. 2 shows a side view of one embodiment of the hitch assembly.

FIG. 2A shows a side view of the same embodiment, showing the movement of pole 18 in plane 18a when adjusted with the locking platform.

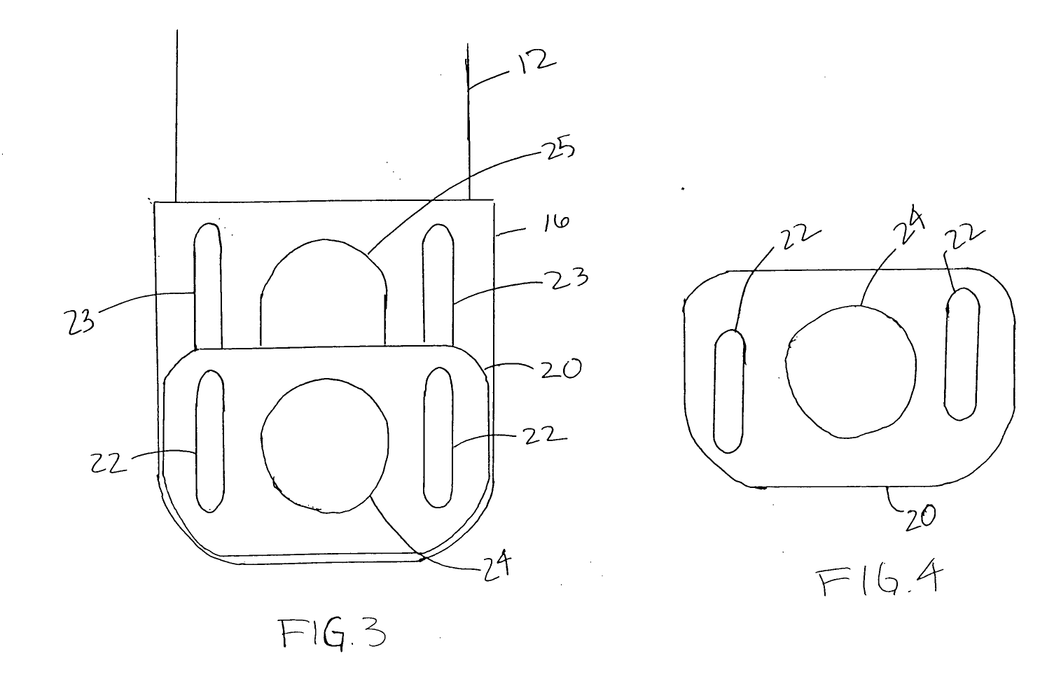

FIG. 3 shows a top view of one embodiment of the upper platform, locking platform, pole-receiving apertures and lock-receiving apertures and locking assembly.

FIG. 4 shows a top view of one embodiment of the locking platform.

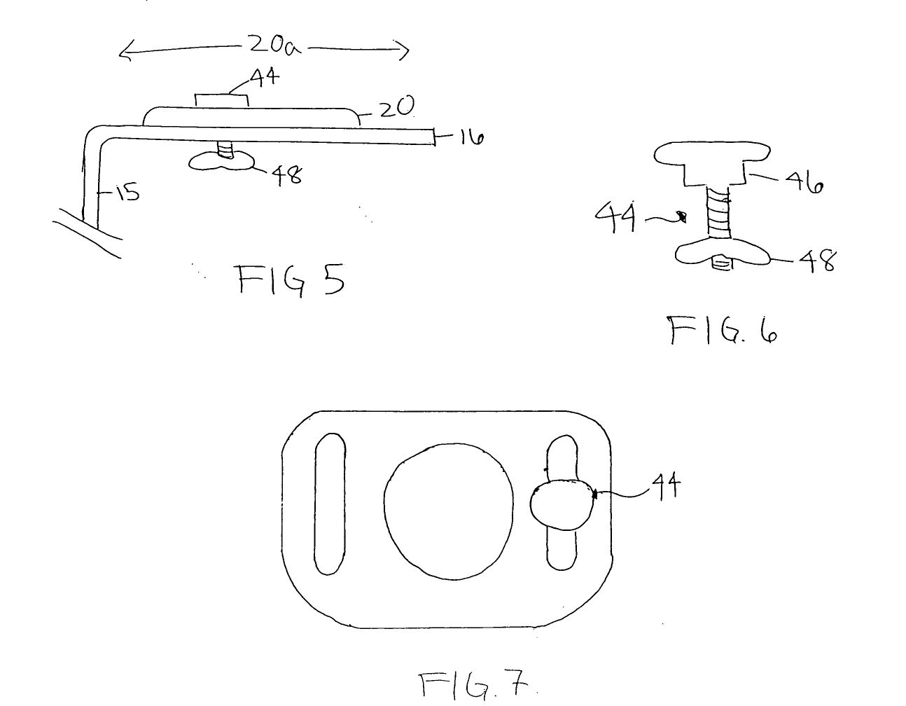

FIG. 5 shows a side view of one embodiment of the locking platform, upper platform and locking assembly.

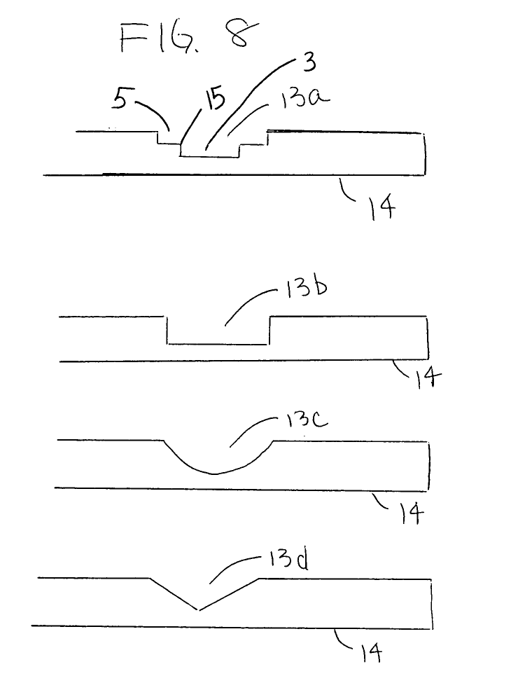

FIG. 6 shows a side view of one embodiment of the lock assembly.

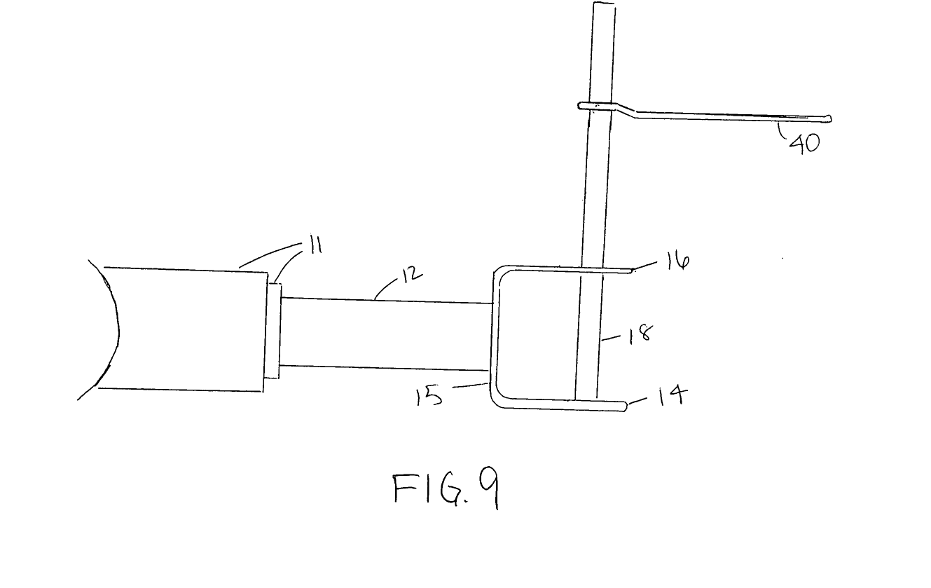

FIG. 7 shows one embodiment of the upper platform and locking assembly.

FIG. 8 shows cut-away, side views of some embodiments of the lower platform.

FIG. 9 shows a side view of one embodiment of the hitch assembly.

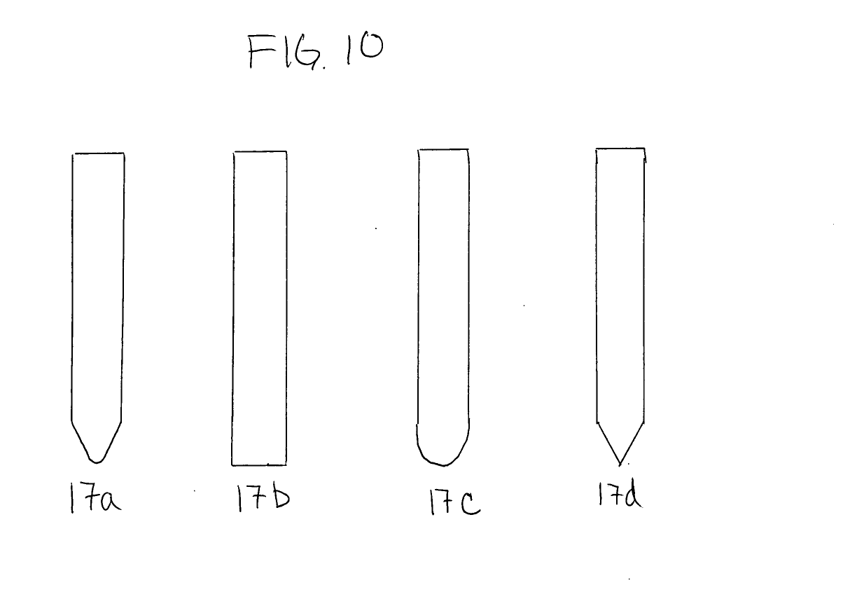

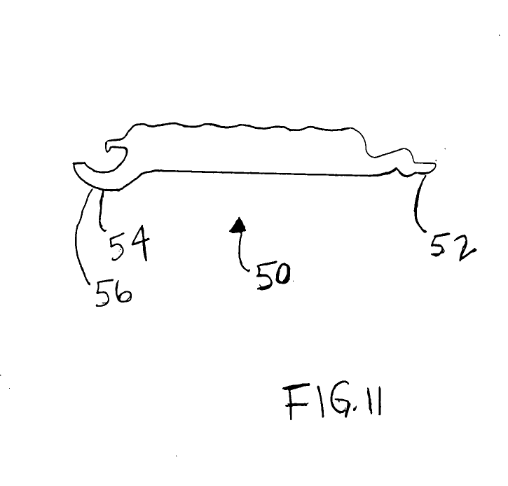

FIG. 10 shows side views of some embodiments of the pole.

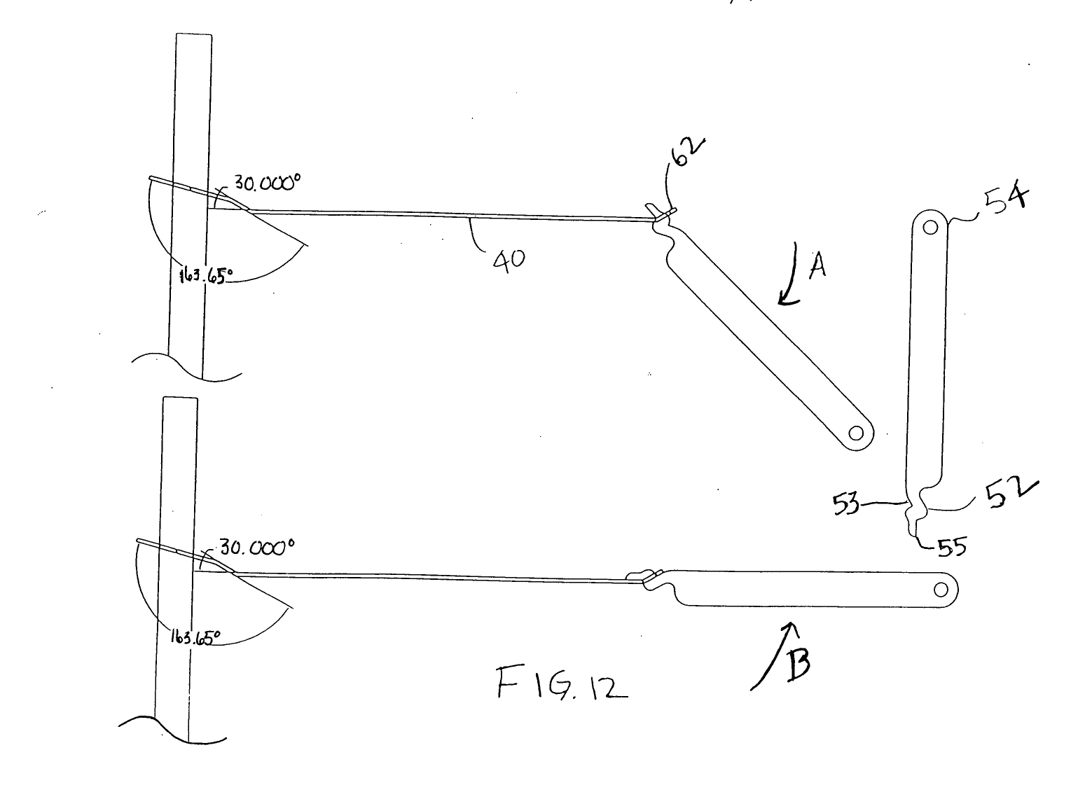

FIG. 11 shows a side view of one embodiment of the handle.

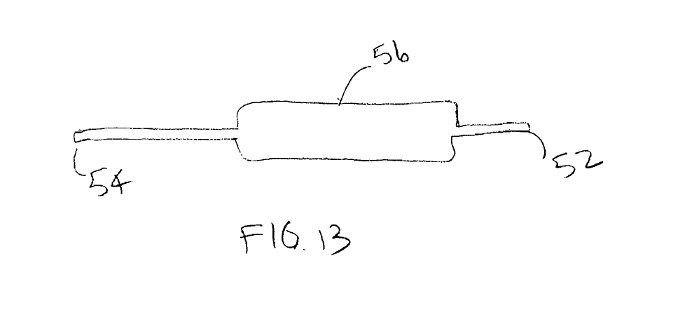

FIG. 12 shows sides views of another embodiment of the handle, and shows sides views of one method of using the handle.

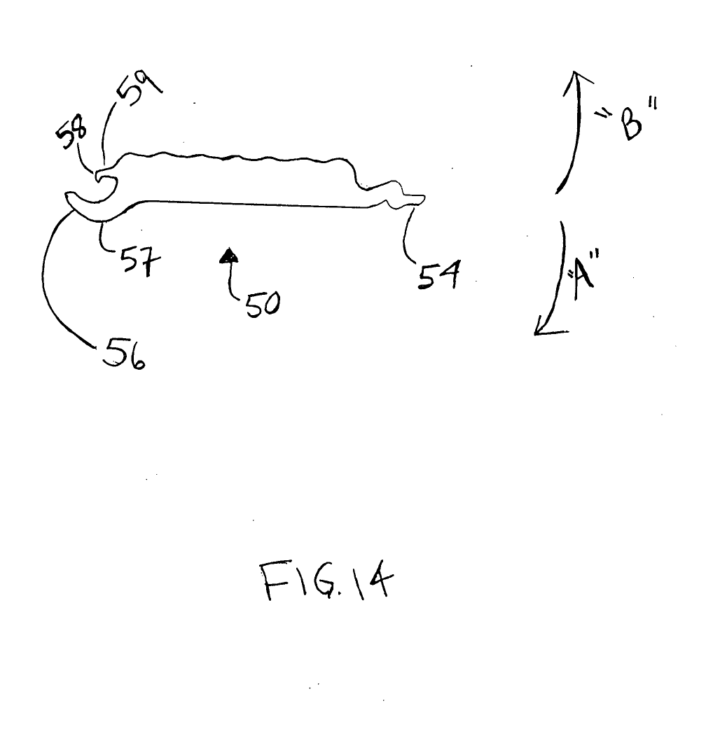

FIG. 13 shows a top view of one embodiment of the handle.

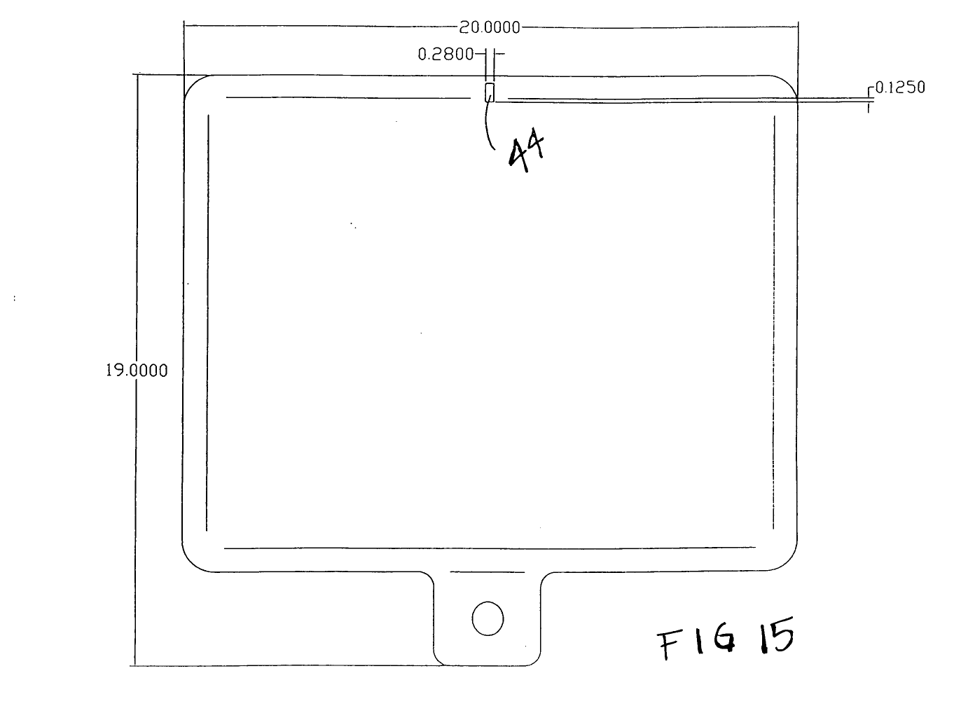

FIG. 14 shows a side view of one embodiment of the handle, and diagrammatically shows another method of using the handle.

FIG. 15 shows a top view of a surface and aperture.

### DETAILED DESCRIPTION OF THE INVENTION

Hitch assembly 10 is removeably attachable to a vehicle hitch 34, and extends from the vehicle hitch away from the vehicle in a generally horizontal direction, generally parallel to the ground. Different embodiments of the invention will extend different distances away from the vehicle. Thus, the length of extender 12 may vary as needed, or may have the ability to telescopically extend and retract through devices already known in the art, such as extension 11, as shown in FIG. 2.

Hitch assembly 10 contains a proximal end 30 and a distal end 32. Proximal end 30 removeably attaches to vehicle hitch 34. Distal end 32 contains a support assembly 36 that securely holds pole 18 in a substantially vertical position, while the pole 18 in turn may support a cooking surface 40, or other item.

Support assembly 36 has three flat platforms, a lower platform 14, an upper platform 16, and a locking platform 20. All three platforms are parallel to each other. Lower platform 14 is permanently connected with upper platform 16 by vertical support 15. Lower platform 14 and upper platform 16 are in a fixed, parallel position relative to each other, and are permanently held in relation to each other by vertical support 15. Lower platform 14 and upper platform 16 are generally parallel to the ground. Locking platform 20 rests on the top surface of upper platform 16 and can move in a parallel plane relative to upper platform 16, while remaining in contact with the upper platform 16.

Locking platform 20 and upper platform 16 each contain at least one pole-receiving aperture 24 and 25 respectively, through which a support pole 18 may be inserted. Locking platform 20 is positioned over upper platform 16 so that its pole-receiving aperture 24 is aligned with pole-receiving aperture 25 of upper platform 16. The lower platform 14 contains no apertures.

To use the device, pole 18 is inserted through the aligned apertures 24 and 25 of the locking and upper platforms 16 and 20. Pole 18 rests on the upper surface of lower platform 14, as shown in FIG. 9. Neither pole 18 nor hitch assembly 10 touch the ground.

In one embodiment lower platform 14 will contain an indentation 13 to receive the bottom end 17 of pole 18. Indention 13 receives bottom end 17 of pole 18, thereby increasing stability for pole 18.

Indentation 13 may come in a wide variety of embodiments and shapes, some of which are shown in FIG. 8. Different indentation embodiments correspond to a shape embodiment of bottom end 17 of pole 18, some of which are shown in FIG. 10. For example, indentation 13d will correspond to bottom end 17d, indentation 13c will correspond to bottom end 17c, indentation 13b will correspond to bottom end 17b, and indentation 13a will correspond to bottom end 17a or 17d. Other indentation and bottom end shapes may be used as needed.

As shown in FIG. 10, different embodiments of bottom end 17 of pole 18 will be pointed 17d, curved 17c, flat 17b, or cone-shaped 17a. Pole-receiving indentation 13 of lower platform 14 will correspond to the pointed, flat, round or cone-shape of the bottom of the pole. Another embodiment of indentation 13 will contain step 15, which creates narrow annulus 3 and wide annulus 5, to further support pole 18. Cone-shaped end 17a or pointed end 17d fits in narrow annulus 3 created by step 15. Step 15 and narrow annulus 3 allow pointed end 17 to pivot in the annular aperture. In yet another embodiment there will be no indentation at all in lower platform 14, and pole 18 will simply rest against the upper surface of lower platform 14, as shown in FIG. 9.

In one embodiment, both pole-receiving aperture 24 of locking platform 20 and pole-receiving aperture 27 of upper platform 16 will be circular holes that are slightly larger than the circumference of pole 18, and sized to receive the pole circumference.

In another embodiment the pole-receiving aperture of the upper platform 16 will be shaped as an elongated oval or capsule shape 25, to accommodate movement in pole 18. Pole 18 is inserted through the pole-receiving apertures of the locking platform 20 and upper platform 16, and comes to rest on the upper surface of lower platform 14. There, bottom end 17 of the pole 18 will act as a fulcrum, allowing pole 18 to move back and forth in a single plane 18a that is perpendicular the horizontal plane formed by the top surface of upper platform 16, and parallel to the direction on extender 12. This back and forth movement allows adjustment of pole 18 so that pole 18 is plumb vertical, or as close to vertical as desired.

This configuration allows the user to make pole 18 plumb vertical, or as close as desired to plumb vertical, even if hitch assembly 10 is not exactly horizontal. For example, the hitch assembly may not be horizontal if hitch assembly 10 is attached to vehicle hitch 34 but is not horizontal as attached. Similarly, if the vehicle is not parked on a horizontal surface hitch assembly 10 will not be precisely horizontal. Nevertheless, the user will likely wish to have pole 18 in as close to plumb vertical as possible, for stability and strength while cooking.

The ability to adjust pole 18 to a plumb vertical position is desirable when attaching cooking surface 40 to pole 18. The vertical position of pole 18 will allow cooking surface 40 to extend in a substantially horizontal position, so that food will not slide around on the surface, and so that heat may be applied evenly to the bottom of the cooking surface 40.

Pole 18 is inserted through apertures 27 and 24. Capsule-shaped aperture 27 of the upper platform 20 allows pole 18 to move back and forth in plane 18a so that pole 18 may be positioned vertical or as close to vertical as desired.

Once pole 18 is vertical, locking platform 20 is used to lock pole 18 in place. Locking platform 20 remains in contact with upper platform 16. Aperture 24 of locking platform 20 is circular, and only slightly larger than the circumference of pole 18. Therefore, when pole 18 is moved in plane 18a locking platform 20 moves back and forth in the direction 20a, which is parallel to extender 12, across the top of upper platform 16. Pole 18 is sized to be somewhat smaller than aperture 24, so that there is very little “play”, that is very little space between pole 18 and the edges of aperture 24. In this configuration, movement of pole 18 will cause locking platform 20 to move also. Once the user has the pole in the desired position (in most cases this position will be plumb vertical) the user will secure locking platform 20 to upper platform 16 using locking assembly 42.

Locking assembly 42 may be made using any means known in the art that allows two surfaces to move relative to each other, and then become secured in a fixed relationship with each other. In one embodiment, locking assembly 42 will comprise a bolt 44 with square shoulders 46 to keep the bolt in position in locking aperture 22. Square shoulder 46 allows the locking assembly to slide in locking aperture 22, and will prevent bolt 46 from turning during tightening. Once pole 18 is in the desired position, wing nut 48 may be used to tighten the bolt, and secure the locking platform in position.

There will be at least one locking assembly 42. In one embodiment there will be two locking assemblies 42. It is obvious that there may be more than two locking assemblies, as desired.

In one embodiment, locking platform 20 will have one or more capsule-shaped lock receiving apertures 22. Each lock-receiving aperture 22 will be positioned on locking platform so that the locking assembly 42 can remain in aperture 22 while locking platform 20 can moves back and forth relative to the upper platform 16. This is useful during adjustment of pole 18 to keep all parts together and allow for ease in tightening locking assembly 42 once pole 18 is substantially vertical.

Upper platform 16 will have one or more similar lock-receiving apertures 23. Again, the lock-receiving aperture 23 will be located on upper platform 16 in any manner that enables locking platform 20 to move relative to upper platform 14, while locking assembly 42 remains in position, and allows locking platform 20 be locked to upper platform 16 using locking assembly 42. One embodiment, shown in FIG. 4 will have two capsule-shaped lock-receiving apertures 23. In this embodiment, each aperture 23 will slightly offset relative to each other and relative to pole-receiving aperture 25. This configuration allows locking platform 20 to be locked to upper platform 16 over a wide range of relative positions of locking platform 20 and upper platform 16. In another embodiment, shown in FIG. 3, the lock receiving apertures are similarly positioned on the locking platform.

Locking assembly 42 is capable of being tightened and loosened, so that when the bolt 44 is loosened, locking platform 20 will be capable of moving in direction 20a.

The hitch assembly 10 may also be made without the locking platform, so that the pole is simply inserted through an aperture in the upper platform and rests on the lower platform, as shown in FIG. 9.

Hitch assembly 10 will be made from any material that is strong enough to support a pole and a cooking surface, or other item besides a cooking surface.

The hitch assembly may be used to cook food by securely connecting hitch assembly 10 with vehicle hitch 34. In a preferred embodiment, the vehicle is positioned so that hitch assembly is projecting from the vehicle as close to horizontal as possible. In other words, it is preferred to park the vehicle on a relatively flat surface, rather than a hill, to use the invention. However, if the vehicle is parked on a hill, the invention may still be used as long as the angle of the parked vehicle allows adjustment of pole 18 to a substantially vertical position.

The proximal end 30 of hitch assembly is connected with the vehicle. Distal end 34 projects away from the vehicle. Pole 18 is inserted through pole receiving aperture 24 of locking platform 20, and through pole receiving aperture 25 of upper platform 16 until the bottom of pole 18 comes in contact with lower platform 14. Depending on which embodiment of lower platform is being used, the bottom of pole 18 may rest in indentation 13, or may simply rest on the upper surface of lower platform 14. In any event, pole 18 remains in contact with lower platform 14.

Pole 18 is adjusted to a substantially vertical position by moving pole 18 in plane 18a. Plane 18a is a plane that is parallel to the direction the hitch assembly extends from the vehicle, and is also perpendicular to the upper platform. Pole 18 is substantially vertical when it is as close to vertical as possible, so that the pole can support a cooking surface or other item. Pole 18 is moved in plane 18a, thereby causing locking platform 20 to move back and forth in plane 20a relative to upper platform 16. Once the user has adjusted pole 18 to a substantially vertical position, the user will lock the locking platform to the upper platform by tightening the locking assembly 42. This will restrain locking platform from moving. Locking platform 20 is secured in position by tightening locking assembly 42. Once locking platform 20 is secured, pole 18 will also be secured and unable to move in plane 18a. It will still be possible to remove pole 18 by lifting it vertically, but pole 18 will not be able to move in any other direction.

In one embodiment, the next step will be attaching an item to pole 18. In one embodiment, the item is a cooking surface that is connected with pole 18. Cooking surface 40 may be adjusted to any height desired along pole 18. The height may be adjusted to accommodate the need for different levels of heat from the heat source, different types of food cooking temperatures, or simply to accommodate the height of the cook to minimize bending.

Cooking surface 40 will extend in a substantially horizontal position away from the vehicle. Substantially horizontal means as horizontal as needed to keep the item to be cooked from falling off the cooking surface.

Because cooking surface 40 extends away from the vehicle, there is sufficient room underneath cooking surface 40 for the user to put a heat source underneath cooking surface 40. Heat from the heat source is directed to the cooking surface, and food items may be cooked on the cooking surface.

After cooking is done, the entire assembly may be removed from the vehicle. Cooking surface 40 is removed from pole 18. Pole 18 is removed from distal end 34 (it is not necessary to unlock locking assembly 42 to remove pole 18). Hitch assembly can be removed from the vehicle, if desired.

Cooking surface 40 becomes hot after use, and may require the use of a handle 50 to move, turn, lift, or otherwise adjust a hot surface.

Handle 50 is used to grasp surfaces while eliminating the need for a person's hand to contact the surface. The handle has a first end 52 and a second end 54. In one embodiment, first end 52 is configured to grasp a surface, while second end 54 has no such configuration, as shown in FIG. 12. In another embodiment, both first end 52 and second end 54 are configured to grasp a surface. In this embodiment, either end may be used to grasp the surface, as desired.

FIG. 13 shows a top view of handle 50. As shown in FIG. 13, handle 50 is narrow. In one embodiment handle 50 may have a support structure 56 to accommodate a hand gripping the handle. This support structure 56 may provide additional protection from heat being transferred along the handle. The support structure may also protect the hand from any sharp or uncomfortable edges on the handle, or may simply provide a wider area for gripping.

First end 52 comprises a multiple curved configuration, when viewed from the side, as shown in FIG. 12. These curves allow the handle to be inserted in an aperture 60 or in a tilted or lipped surface 62. In one embodiment, it has at least curve 63 and tip 65.

End 52 is positioned into aperture 60 in tilted surface 62 by first angling second end 54 down in direction “A” (see FIG. 12) and inserting tip 65 through the aperture 60. Second end 54 is then lifted in direction “B” upwards, allowing curve 63 to rest against tilted surface 62, and tip 65 to rest against the top surface of surface 40. This action secures the handle against the surface, and allows the user to lift, turn, move or otherwise adjust the surface without coming in contact with the surface.

In another embodiment, end 56 is used to contact surface 40. End 56 comprises curve 57 and projection 59 and latch 58. End 56 is positioned in aperture 60 in tilted surface 62 by first angling second end 54 down in direction “A” and inserting curve 55 through aperture 44 in tilted surface 40. End 54 is then moved in direction “B” upwards, allowing projection 59 to rest against tilted surface 42, and latch 59 to secure tilted surface 42.

What is claimed is:

1. An assembly for removeably attaching a pole to a vehicle, comprising:
a hitch assembly with a proximal end and a distal end with a distal support assembly, wherein said proximal end is removeably attachable to a vehicle hitch,
wherein said distal support assembly comprises
a lower platform,
an upper platform with at least one pole receiving aperture and at least one lock-receiving aperture,
a vertical support permanently connecting said lower platform to said upper platform in a parallel position relative to each other,
a locking platform with at least one pole receiving aperture and at least one lock-receiving aperture wherein said locking platform moveably rests on said upper platform
at least one locking assembly positioned in both the upper platform lock-receiving aperture and the locking platform lock-receiving aperture wherein said locking assembly has a means to tighten and lock
a pole that is capable of being removeably inserted in the pole receiving apertures of both the upper platform and locking platform and resting on said lower platform.

2. The device of claim 1 wherein the distal end extends away from the proximal end by a telescopic extender.

3. The device of claim 1 wherein the lower platform has an indentation.

4. The device of claim 3 wherein the indentation is selected from the group consisting of a double annulus, a flat indentation, a curved indentation and a cone-shaped indentation.

5. The device of claim 1 wherein the pole has a bottom end, and said bottom end is selected from the group consisting of flat, cone-shaped, curved or pointed.
